(19) United States
(12) Patent Application Publication
(10) Pub. No.: US 2005/0276834 A1
(43) Pub. Date: Dec. 15, 2005

(54) Mole bait and systems and methods for making and using an improved mole bait

(76) Inventors: Peter Martin, Pewaukee, WI (US); Simone Jeans, Albany, WI (US); John Derer, Madison, WI (US); Daniel C. Johnson, Madison, WI (US)

Correspondence Address: LATHROP & CLARK LLP, 740 REGENT STREET SUITE 400, P.O. BOX 1507, MADISON, WI, 537011507, US

(21) Appl. No.: 10/866,010

(22) Filed: Jun. 11, 2004

(51) Int. Cl. A01N 25/08

(52) U.S. Cl. 424/410

(57) ABSTRACT

A mole bait article replicates fine details of a particular prey animal of a mole. A mole bait article that mimics a worm can include an anterior portion, including segments and the head, the clitellum, and an posterior portion, including segments and the tail. Physical properties of the worm, such as elasticity, recovery, and the like can also be mimicked by the mole bait. The mole bait article is formed by pouring or injecting a mold bait material into a mold area in a disposable substrate that defines a specific shape of a mole prey animal. Disposable substrates can be inserted into a resealable pouch, which may then be placed into a box. The mole bait article is used by removing a disposable substrate from the resealable pouch, removing mole bait articles from their corresponding depressions in the substrate, and introducing the removed mole baits into active mole tunnels.

### BACKGROUND OF THE INVENTION

1. Field of the Invention

This invention is directed to an improved mole bait that more accurately represents a prey animal and systems and methods for making, packaging and using the improved mole bait.

2. Related Art

Moles are commonly small, fossorial mammals about five to eight inches in length, with an elongated, highly mobile snout. Moles generally lack external ears and have tiny, barely detectable eyes. Moles' most distinguishing features are their stubby, broad, shovel-like front feet, which are well adapted to digging.

Moles live underground and seldom venture out of their burrows. The ridges produced by their burrowing plainly indicate their presence. It is well understood that most of the tunnels dug by moles are made in a random search for food, so that many of the tunnels dug by a mole are rarely reused. Moles' more permanent, or “active” tunnels usually run along fences, borders, or other protective places that lead to feeding areas.

It is also well understood that moles are predators that feed almost exclusively on soil-based prey, such as earthworms, grubs, insect larva and adult insects. However, grubs and, especially, earthworms are the most important food sources. U.S. Pat. Nos. 6,264,969 to Poche and 4,520,015 to Pesche disclose two conventional mole baits that are alleged to eliminate moles from a particular area. The '969 patent discloses a bait composition that is in the form of a gel, paste, or grease, which is injected by syringe or the like into a tunnel created by the mole. As disclosed in the '969 patent, the bait composition comprises an attractant and an active ingredient, such as, for example, a poison.

In particular, the bait composition includes a gelling agent that is preferably water soluble and is present in amounts of about 35% to 75% by weight. The '969 patent identifies a number of useful gelling agents, including methylcellulose, sorbitol, food gums, gelatin, non-petroleum greases that are biodegradable, and the like. As disclosed in the '969 patent, from 0.25 to 1 ounce of the bait composition should be injected at each selected location along the mole tunnels. The '969 patent states that using that the small diameter nozzle, tube or needle, there is minimal disturbance of the soil and the tunnel is neither opened nor collapsed or caved in.

The '015 patent discloses a bait for destroying harmful animals that is prepared by forming a fluid, aqueous paste containing nutritive elements, at least one constituent which is toxic to the target animal, and a gellable constituent. The prepared paste is placed into a desired shape for the final product and is then gelled. The gelled product is then preserved in a slight acidic, aqueous, saline medium or under a vacuum or an inert gas. As disclosed in the '015 patent, the nutritive elements include glucides and protides and are mixed with water such that the mixture obtained is still very liquid. Binders and gellable agents are then added to the very liquid mixture. The gellable constituent is preferably an alkali metal alginate, such as sodium alginate, which is about 0.8% to 2% of the finished gellable product.

The '015 patent discloses that, at this stage, the product is in the form of a paste or a gel, which is then put into its final desired shape, which is a function of the intended use. Various shapes identified in the '015 patent include, for example, a ball, a filament, a small earthworm, a large worm, a granule, a bead, a small noodle, a small shell-shaped product and the like. However, the only disclosure in '015 patent for obtaining the desired shape comprises using an extrusion nozzle connected to a container containing the product and to an intermediate metering device, which conveys to the nozzle the appropriate amount of the product. Thus, depending on the shape of the nozzle, spherical or oblong products or ribbons of various width, etc., may be obtained. That is, the shape and the dimensions of the end of the extrusion nozzle essentially determine the shape of the final bait.

Once the product is put into the final desired shape, the shape of the product is fixed by gelling it, that is, by setting its mass. As disclosed in the '015 patent, this gelling is achieved by applying a gelling agent to the product containing the gellable constituent. In particular, the '015 patent teaches that the shaped product may be introduced into the gelling agent either by falling freely into a solution of the gelling agent or by directly introducing the product emerging from the extrusion nozzle into a bath containing the gelling agent.

### SUMMARY OF THE DISCLOSED EMBODIMENTS

While the '969 and '015 patents both purport to disclose effective mole baits, it is widely understood that, since moles feed mostly on insects and earthworms, moles rarely eat baits, especially cereal-based baits. Thus, it is widely understood that baits are seldom effective. Through extensive observations of the hunting and feeding habits of moles, the applicants have developed an effective mole bait that plays to these habits.

This invention provides a mole bait article that imitates or mimics at least one of a feel and a shape of a prey animal to a mole.

This invention separately provides a mole bait article that is specifically shaped to substantially imitate or mimic at least one of a shape and a feel of a worm.

This invention separately provides a mole bait article that imitates or mimics at least one of an elasticity or stretchability and a recovery of a worm when imitating or mimicking the feel of the worm.

This invention separately provides a packaged mole bait product having at least one substrate that contains at least one depression in a first surface, where at least one such depression has a negative shape relative to a desired shape of a mole bait article.

This invention separately provides a packaged mole bait product where the mole bait article is formed by introducing a quantity of a moldable mole bait material into one or more depressions in one or more substrates, where each depression is specifically shaped to imitate or mimic the shape of a prey animal of a mole.

This invention separately provides a mole bait product, where one or more substrates, containing one or more depressions having shapes specifically corresponding to prey animals of the mole, are placed into a resealable pouch.

This invention separately provides a method for making a mole bait article comprising molding the mole bait article into a specific shape of a prey animal.

This invention separately provides systems and methods for making a mole bait article, where the molds used to mold the mole bait material are also used to distribute the molded mole bait articles.

This invention separately provides systems and methods for introducing a mole bait article into an environment where it is likely to be encountered by a mole, including opening a resealable pouch containing at least one substrate having depressions that contain at least one mole bait article, removing at least one such tray from the pouch, removing at least one such mole bait article from the at least one tray, and placing each removed mole bait article into the mole's environment.

This invention separately provides systems and methods for killing a mole, including placing a mole bait article that is shaped like a prey animal of a mole into an environment where the mole is likely to encounter the mole bait article, such that the mole, when encountering the mole bait article, reacts to the mole bait article in substantially the same manner as to the corresponding prey animal, such that the mole “hunts” and consumes the mole bait article as if it were the prey animal that the mole bait article mimics.

In various exemplary embodiments, a mole bait article according to this invention is molded to replicate or mimic the fine details of a particular prey animal that is being mimicked by the mole bait article. For example, if the mole bait article mimics a worm, the mole bait article includes an anterior worm portion, including details such as segments, the shape of the head and possibly other specific details of the anterior portion of the worm, the clitellum portion of the worm, and the posterior portion of the worm, including specific details such as segments, the shape of the tail of the worm and possibly other specific details of the posterior portion of the worm.

In various other exemplary embodiments, physical properties of the worm, such as an amount or degree of stretch along the axis of the worm, an elasticity or resistance to stretch along the axis of the worm, a recovery from stretch of the worm, and the like are mimicked by the mole bait article according to this invention. In yet other exemplary embodiments, both the shape and the physical properties of the worm are mimicked.

The applicants of this invention have discovered, through extensive observations of hunting and eating behaviors of moles with respect to prey animals and mole bait articles of various shapes, that moles rely on the fine details of the shape of the prey animal to identify that the thing encountered by the mole is in fact the prey animal. Thus, if the mole cannot identify such fine shape features in the mole bait article that the mole expects to find in the prey animal, the mole is not likely to be deceived into treating that mole bait article as a prey animal. Accordingly, the mole is highly likely to reject such a mole bait article, regardless of the attractants used to entice the mole to consume the mole bait article. Similarly, the applicants have discovered that, in view of the mole's feeding habits, for a mole bait article that does not well mimic the physical properties of the prey animal being mimicked, even if the mole begins ingesting such a mole bait article, it is unlikely that the mole will consume such a mole bait article in sufficient quantities to receive an effective amount of the active ingredient contained within the mole bait article.

In various exemplary embodiments, the mole bait article according to this invention is formed using a mold that defines a specific shape of a mole bait article. In various exemplary embodiments, mole bait material is introduced into the mole bait article mold by pouring and/or injecting. In various exemplary embodiments, a disposable substrate having a plurality of mold portions that define a negative image of the prey animal being mimicked is used to create the molded mole bait article. In such exemplary embodiments, one or more of the disposable substrates are introduced into, and sealed within, a resealable pouch, which may then be placed into a box, for distribution to an end user.

In various exemplary embodiments, the mole bait article according to this invention is used by removing at least one disposable substrate from the resealable pouch, removing one or more of the mole bait articles from their corresponding depressions in the removed substrate(s), and introducing the removed mole bait articles into active mole tunnels. In various exemplary embodiments, using the mole bait articles according to this invention includes identifying possibly-active lengths of a mole tunnel and creating a number of test holes in the identified possibly-active length of the mole tunnel. If the identified length of the mole tunnel is active, the mole, as it travels along that portion of the tunnel, will repair the test holes. The test holes are then inspected to confirm that the identified length of the mole tunnel is, in fact, active. A number of bait holes are then made in the active length of the mole tunnel. For each bait hole, a mole bait article according to this invention is removed from the tray and inserted into the mole tunnel through that bait hole. As part of inserting the mole bait article according to this invention into the mole tunnel, the entire length of the mole bait article is introduced into the mole tunnel and the entire length of the mole bait article is placed on the floor of the mole tunnel. Each bait hole, some time after inserting the mole bait article, is then carefully closed.

In various exemplary embodiments, once a mole bait article according to this invention is introduced into an active mole tunnel, when the mole comes upon the mole bait article according to this invention, the mole, because the mole bait article according to this invention sufficiently closely mimics the prey animal, attacks the mole bait article as if it were the prey animal being mimicked. Once the mole has successfully “hunted” the mole bait article, as if it were the mole prey animal, the mole consumes the mole bait article as if it were the prey animal. Once the mole has consumed the mole bait article, the mole bait article is readily and easily digested by the mole, releasing the active ingredients from the mole bait article into the mole. In various exemplary embodiments, the active ingredients include an effective poison, medicine, nutrition, other veterinary drugs or any other desired and/or appropriate active ingredient. In various exemplary embodiments, an effective amount, such as a therapeutically effective or lethally effective amount, or dose of the active ingredient is released from the mole bait article into the mole as it is digested.

These and other features and advantages of various exemplary embodiments of the mole bait articles, and systems and methods for making and using such mole bait articles according to this invention, are described in, or are apparent from, the following detailed descriptions of various exemplary embodiments of the mole bait articles and the systems and methods for using such mole bait articles according to this invention.

### BRIEF DESCRIPTION OF DRAWINGS

Various exemplary embodiments of the mole bait articles and systems and methods for making and using such mole bait articles according to this invention will be described in detail with reference to the following figures, wherein:

FIG. 1 is a top perspective view of a prey-animal mole bait article according to this invention that is specifically shaped like a worm;

FIG. 2 is a top perspective view of one exemplary embodiment of a substrate having a number of molded depressions according to this invention;

FIG. 3 is a bottom plan view of the substrate shown in FIG. 2;

FIG. 4 is a cross-sectional view of one such substrate, a pouch containing one such substrate and a box containing one such pouch according to this invention;

FIG. 5 is an bottom perspective view of one substrate, the pouch and the box shown in FIG. 4;

FIG. 6 is a flowchart outlining one exemplary embodiment of a method for making a molded prey-animal mole bait article having specific prey-animal features according to this invention;

FIG. 7 is a flowchart outlining one exemplary embodiment of a method for using a molded prey-animal mole bait article having a specific prey-animal shape according to this invention;

FIG. 8 is a flowchart outlining one exemplary embodiment of a method for introducing a molded prey-animal mole bait article having a specific prey-animal shape according to this invention into an environment where the mole is likely to encounter the molded prey-animal mole bait article;

FIG. 9 is a flowchart outlining one exemplary embodiment of a method by which a mole interacts with a molded prey-animal mole bait article having a specific prey-animal shape according to this invention; and

FIG. 10 is a flowchart outlining one exemplary embodiment of a method for introducing an active ingredient into a mole using a prey-animal mole bait article having a specific prey-animal shape according to this invention.

### BRIEF DESCRIPTION OF EXEMPLARY EMBODIMENTS

Most knowledge regarding the feeding preferences of moles has been obtained by examining the stomach contents of captured and euthanized moles. Examining the stomach contents of such captured moles has shown that moles are primarily carnivorous, with a diet that focuses on soil insects and their larva, slugs, snails and, especially, earthworms. That is, of these potential prey animals, the earthworm appears to be the mainstay of the mole diet. For example, the stomach contents of necropsied animals commonly contain more than 90% earthworm remains by weight. While this has provided some understanding of the types of prey animals preyed upon by moles, this has provided no information or knowledge regarding the hunting and feeding habits of wild moles.

Previously, captured moles have been extremely difficult to keep alive in captivity, even when provided with food derived from their main prey animals. However, prior to studies undertaken by the applicants and their colleagues, the reasons for such failure of moles held in captivity were not perfectly understood.

To remedy this lack of complete understanding of mole biology and ecology, the applicants, along with their colleagues, conducted a long-term study of moles and their hunting and feeding habits. In particular, the applicants have determined that moles possess a very distinctive method for consuming earthworms. In particular, when a mole encounters an earthworm, the mole first grasps the earthworm and manipulates the earthworm until the mole finds the clitellum of the earthworm. Because the mole is almost always underground at this time, and thus cannot see the earthworm, especially in view of the mole's generally small, undeveloped eyes, the mole does this almost exclusively by feel. This is true even if the mole is able, by smell and/or taste, to tentatively identify the encountered object as a worm.

Once the mole locates the clitellum, the mole identifies the anterior portion of the worm, which is typically significantly smaller than the posterior portion of the worm, and locates the front segment of the worm that contains the brain and beginnings of the central nervous system of the worm. The captured earthworm is then immobilized by severing the central nervous system, thus separating the brain from the rest of the body of the worm. In general, the central nervous system is severed by the mole biting the head portion and, possibly, other portions of the anterior portion of the worm at least once, if not repeatedly.

The mole then positions the worm head-first into its mouth using its front paws. The earthworm is consumed by the mole alternately biting the body of the worm, stretching the portion of the worm outside of the mole's mouth, allowing the worm to relax, and then biting further down the worm's body from the head of the worm and swallowing the portion of the worm thus brought into the mole's mouth. The mole repeats this procedure until the worm is entirely swallowed. As a result of this process, the worm, as ingested into the mole's stomach, is generally not significantly or thoroughly masticated. That is, examinations of moles' stomachs have revealed that the earthworm is swallowed in large segments and not thoroughly masticated, as expected by the moles' sharp sets of teeth.

The long-term observations of mole hunting and feeding behavior by the applicants and their colleagues have determined that moles generally have a very high rate of passage of food through the moles' digestive track. In particular, a mole will consume an earthworm, digest it and excrete the undigested portions of the worm in approximately four to five hours. While specific causes have not been determined, unidentified but unique aspects of a mole's physiology have indicated that sufficiently large concentrations of poisons and the like are difficult to build up in the mole's body. Thus, many poisons, such as warfarin®, will generally be ineffective, as the concentrations of such poisons that can be built up in the mole's body using conventional mole baits are not lethal.

It should be appreciated that, while consuming the earthworm, the mole has effectively stretched at least a portion of the earthworm to its full length using its front paws. There are many theories for this peculiar behavior. The most plausible theory suggests that this behavior is a unique adaptation that results in removing any residual soil and/or earthworm casts that remain in and/or on the earthworm that is being consumed from the earthworm before consumption. This method of consumption has two distinct benefits: a) removing soil and/or casts from the worms' skin and/or digestive tracts tends to prevent premature wear on the moles' teeth due to abrasion from the soil and/or casts; and b) due to the moles' high food consumption rate and rapid digestive rate, removing particles with little or no nutrition value allows the moles' digestive tracks to extract the maximum food value of each consumed food particle.

In addition, due to moles' distinctive hunting and feeding habits regarding earthworms, the applicants have discovered that moles will generally not consume, and probably will not consume, sufficient quantities of mole baits which do not sufficiently mimic the shape of a worm that a mole expects to encounter. Thus, mole baits, regardless of their underlying attractiveness to moles in view of their taste and/or smell, that do not have the specific shape of the prey animal that the mole believes it has encountered, will not be consumed by the mole. For example, for a mole bait that has an amorphous shape, such as a ribbon of a bait composition, in the form of a gel, paste or grease, that has been injected into a mole tunnel by a syringe or the like, or for a mole bait that has a shape that at most grossly corresponds to the shape of a worm, such as a long tubular, extruded, gelled product, but that does not contain the specific shape features and/or physical properties of the worm that a mole expects to encounter, the mole typically will not consume the bait composition or gelled product.

Based on the applicants' observations of mole behavior when various experimental mole bait articles that are only grossly worm-shaped are placed into the moles' environment, the applicants have discovered that, when the mole cannot identify by feel the various body portions of the worm that the mole expects to find, the mole cannot identify the “head” portion of the item the mole has encountered and initially believes to be a worm. Since the mole cannot identify the head portion of the item, the mole can neither sever the “nervous system” of the item nor begin ingesting the item at the “head” portion while expelling the “digestive track contents” of the item through its “tail” portion. As a result, the mole abandons the bait item, even if the bait item smells and tastes like a worm to the mole. Thus, the applicants have discovered, through testing various mole bait article shapes/structures, that it is not sufficient for a mole bait article to have the taste or smell of a worm, nor even to have the general or gross shape of a worm. Rather, the applicants have discovered through testing various mole bait article shapes/structures, that a successful mole bait article desirably imitates or mimics the body portions of the prey animal that the mole expects to encounter when the mole tactilely examines the mole bait article when deciding how to interact with the mole bait article that the mole is to be deceived into believing is a prey animal.

Additionally, the applicants have discovered that, based on extensive observations of mole hunting and feeding habits and behaviors with respect to various experimental worm-shaped mole bait articles, even if a mole can be induced to begin consuming a worm-shaped mole bait article which does not have the specific shape characteristics and features of a worm, the mole will not finish consuming the worm-shaped mole bait article if the mole bait article does not adequately react to the stretching and releasing actions of the mole as it consumes the worm-shaped mole bait article. That is, if the mole bait article either does not stretch sufficiently like a worm, either because it is either too hard to stretch or too easy to stretch, or if the mole bait article does not recover from the stretching action by the mole sufficiently similarly to that of a worm, either by failing to recover sufficiently, or by over-recovering, the mole will often abandon the mole bait article.

An earthworm comprises a series of small, fluid-filled segments, connected end-to-end. A thin elastic membrane called a septum separates each segment. The septum allows each segment to function independently. Each segment possesses a pair of antagonistic muscles. One set of these muscles extends circumferentially around the outer periphery of the worm, causing the shape of the segments to compress and expand to force body fluids, which are mostly water, toward each end of the segment, i.e., toward both the anterior and posterior ends of the worm. This squeezing action of these circumferential muscles causes bodily fluids to be redistributed throughout the segment, subsequently causing the segment to appear long and thin. A second set of segment muscles extends longitudinally along the long axis of the worm's body. These longitudinal muscles extend through two to three adjacent segments. When these longitudinal muscles contract, the fluid moves 360° around the diameter of the worm, resulting in the segmenting taking on a short and wider appearance.

Earthworms move by contracting the circumferential muscles at the head or anterior end of the worm. During this action, the longitudinal muscles in each segment relax, causing the circumference of the segment to decrease and the length to increase as necessary to maintain the volume for the bodily fluids. Subsequently, the circumferential muscles relax and the longitudinal muscles contract, causing the segment length to shorten and the circumference to increase. As the worm moves forward, successive peristaltic or contracting waves of thickening or thinning appear to pass long the body. As each segment expands, the bristles or setae of that segment are extended to grip the soil. The setae push against the ground with each contraction and help the worm move. This system of liquid transfer allows the earthworm segments to shorten themselves up to one-quarter of their elongated length.

Moles exploit these same sets of circumferential and longitudinal muscles as they consume their prey. Accordingly, an appropriate mole bait article according to this invention should, but may not need to, possess adequate elasticity to allow the mole to stretch the mole bait article during consumption without breaking the mole bait article. An appropriate mole bait article may also possess adequate tensile strength to prevent the mole bait article from breaking and/or a sufficient recovery parameter to allow the mole bait article to recover from the stretching action of a mole in a manner that is sufficiently similar to the prey animal being imitated or mimicked by the mole bait article.

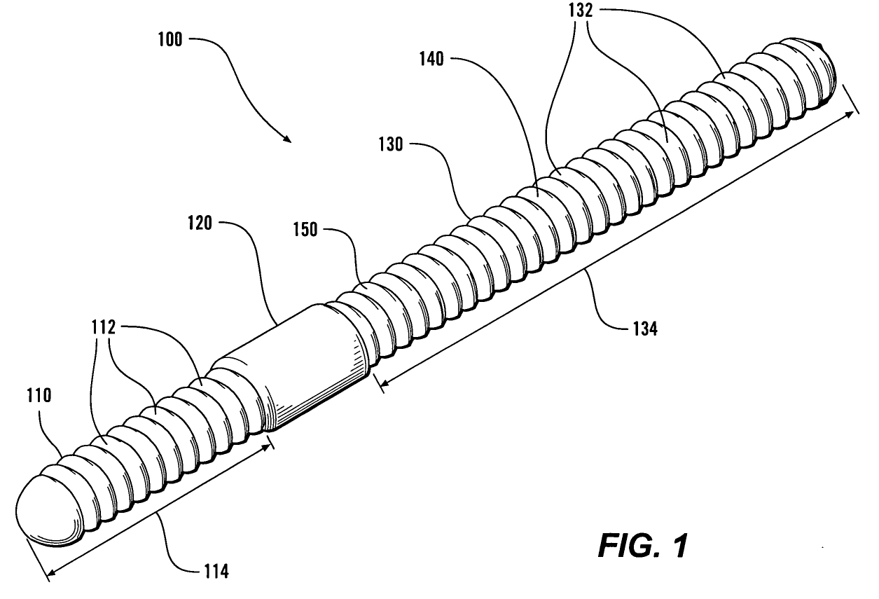

FIG. 1 is a top perspective view of one exemplary embodiment of a mole bait article that imitates or mimics the specific shape characteristics of a typical prey animal of a mole. In particular, the prey animal shown in FIG. 1 that the mole bait article 100 mimics is a worm. In this exemplary embodiment of a mole bait article according to this invention, the mole bait article or worm 100 includes an anterior portion 110 having a plurality of anterior segments 112 having an appropriate length 114 and a clitellum 120 that is located at an appropriate position along the length 102 of the worm 100. The worm 100 also includes a posterior portion 130 having a number of posterior segments 132 and a length 134 that is generally in an acceptable range of lengths relative to the overall length 102 of the worm 100.

In particular, the specific shapes of the anterior and posterior segments 112 and 132, the lengths 114 and 134 of the anterior and posterior portions 110 and 130 and the size and location of the clitellum 120 are sufficiently similar to that of a typical earthworm such that a mole, when encountering the mole bait article 100, will be able to sufficiently identify the clitellum 120, the anterior portion 110 and the posterior portion 132 such that the mole will be able to locate what it believes to be the head portion of the mole bait article 100, sever what the mole believes to be the “central nervous system” of the mole bait article 100 and subsequently put the mole bait article 100 into its mouth and consume the mole bait article 100 as outlined above.

Similarly, in various exemplary embodiments of the mole bait article according to this invention that mimics a prey animal, such as a worm, includes one or more regions, such as the areas between the segments 112 and/or 132, i.e., the regions that separate the segments 112 and/or 132, that have a dimension d₁ across the length of the mole bait article 100, that is less than a dimension d₂ of the segments 112 and/or 132 themselves. Likewise, the dimension d₂ of the segments 112 and/or 132 across the length of the mole bait article 110 is less than a dimension d₃ of the clitellum 120 across the length of the mole bait article. Stated another way, this dimension d₃ of the clitellum 120 is greater than the corresponding dimension d₂ of the segments 112 and/or 132. Finally, in various exemplary embodiments of the mole bait article, the ends of one or both of the anterior and posterior portions 110 and 130 of the mole bait article 100, which correspond to the head and tail of the worm, respectively, taper, rather than ending abruptly. It should be appreciated that, in various exemplary embodiments, for mole bait articles that mimic other prey animals, such as grubs, insect larva, adult insects and the like, the mole bait articles will have similar regions of relatively lesser and/or greater dimension and/or tapering end portions that mimic areas of reduced, thickened and/or tapering body shape and/or size of the prey animal.

In various exemplary embodiments, to improve the ability of the mole bait article 100 to deceive the mole into believing the mole bait article 100 is an actual earthworm, various exemplary embodiments of the mole bait article 100 have a stretchability and a recovery that tend to mimic those of an actual worm. In various exemplary embodiments, the mole bait article 100 according to this invention contains a combination of proteins and plasticizers that provide the mole bait article 100 with an elasticity value that tends to deceive the mole as to the nature of the mole bait article 100 as it is consumed. In various exemplary embodiments of the mole bait article 100 according to this invention, the mole bait article 100 was formed by combining a collagen protein with sorbitol and glycerin.

Based on observations of a captive mole population as the moles interact with various sample mole bait articles according to this invention, the applicants have determined that this captured population of moles is deceived by the mole bait article 100 when the mole bait article 100 has an elasticity and tensile strength such that at least a portion of the mole bait article 100 can be stretched to between about 150% to about 200% of its original, pre-stretch length before the mole bait article 100 breaks. The mole bait article 100 tends to be more deceptive to the captured population of moles when the elasticity and tensile strength of the mole bait article 100 combine so that at least a portion of the mole bait article 100 can be stretched to between about 155% to about 175% of its pre-stretch length. An even more deceptive mole bait article 100 has an elasticity and tensile strength that combine to provide a mole bait article 100 having at least a portion that extends to between about 157% to about 160% of its original, pre-stretch length. One specific example of such an even more deceptive mole bait article 100 has an elasticity and tensile strength that combine so that at least a portion of the mole bait article 100 extends to about 158% of its original, pre-stretch length before the mole bait article breaks.

Similarly, a mole bait article 100 that tends to deceive the captured population of moles that the mole bait article 100 is a prey animal, such as a worm, has an elasticity memory that returns the mole bait article to a post-stretch length of between about 100% to about 108% of the original, pre-stretch length of the mole bait article 100. An even more deceptive mole bait article 100 has an elasticity memory that returns the mole bait article 100 to a post-stretch length of 102% to 107% of the original, pre-stretch, length. An even more deceptive mole bait article 100 has an elasticity memory such that the mole bait article 100 returns to a post-stretch length of between about 104% to about 106% of the original, pre-stretch, length. One specific example of such an even more deceptive mole bait article 100 has an elasticity memory that returns the mole bait article 100 to a post-stretch length of about 105% of its original, pre-stretch length.

It should be appreciated that, in various exemplary embodiments, the ranges for elasticity and recovery discussed herein were determined objectively by applying tension to the mole bait article 100 under lab conditions. In various exemplary embodiment, the ranges of values for the elasticity were determined by stretching the mole bait article 100 to a to a predetermined value, while measuring the length of the mole bait article 100 before and after the application of force.

As indicated above, the mole bait article according to this invention contains a combination of proteins and plasticizers that provide a range of elasticity during mole consumption as outlined above. In various exemplary embodiments, a combination of collagen protein coupled with two carbohydrates can be used to create a mole bait article having an elasticity, a distance to break, a tensile strength and/or an elasticity memory within one or more of the above-outlined ranges. In particular, a mole bait article comprising gelatin as the collagen protein and sorbitol and glycerin as the two carbohydrates can be used to create a mole bait article having an elasticity, a distance to break, a tensile strength, and/or an elasticity memory that lies anywhere within the above-outlined ranges.

In this mole bait article, the gelatin acts as a elastomer, while the sorbitol and glycerin each acts as a plasticizer. The elastomer component provides, at least in part, the stretchability (or, inversely, the resistance to stretch) and recoverability properties to the mole bait article. The elastomer also provides viscosity to the mole bait article. However, many elastomers, such as gelatin, are too rigid. The plasticizer component provides, at least in part, flexibility and fluidity to the mole bait article.

It should be appreciated that gelatin, and sorbitol and glycerin, respectively, are usable as the elastomer and the plasticizer in the mole bait article at least in part because they are edible and digestible, and are otherwise palatable and attractive to moles. That is, as discussed above, the applicants have determined, based on observations of moles undertaken by the applicants, that moles typically pass food items through their digestive system in approximately four hours. Stated another way, moles have very low dwell times for food items in their digestive tracts. This is not surprising considering that worms are, by a wide margin, moles' primary food source. As a result, a mole bait article, to have an optimal effect on the mole, should be digestible by a mole within the same time frame. This also implies that moles are generally not able to adequately digest cellulose-based food products, because the mole's digestive system does not provide for sufficient residence time in its intestines to get nutrition from cellulose-based food products. This also is not surprising, as moles in the wild generally do not consume cellulose.

As discussed above, worms are basically a protein coat around liquid nutrients. As also discussed above, moles do not thoroughly masticate worms, or bait articles, as they are consumed. With respect to worms, thorough mastication by the mole is not necessary. An animal generally thoroughly masticates food to increase the food's surface area, to allow enzymes and digestive juices better access to the entire mass of food. However, with a worm, a few bites by the mole through the worn's protein coat both allows the worm's internal fluids to leak from the worm and allows the mole's digestive juices to readily enter into the interior of the worm for additional digestion of the worm's body.

When a mole bait is introduced into the mole's environment as a gel, the digestibility of the gel mole bait is generally not an issue. That is, gel mole baits are generally semisolids that moles lick up. Thus, moles ingest gel mole baits as semiliquids that are readily digestible by the mole.

For the mole bait article according to this invention, in various exemplary embodiments, the elastomer and the plasticizer(s) used in the mole bait article according to this invention should be, and desirably are, selected so that the mole can sufficiently digest a single mole bait article, during the single mole bait article's presence in the mole's digestive system, to release at least a full dose of the active ingredient contained in the single mole bait article. It should be appreciated that the combination of the gelatin, the sorbitol and the glycerin is desirably readily digestible by the mole such that the mole receives at least a full dose of the active ingredient contained within the mole bait article between the time that the mole bait article is first consumed to when the mole is done digesting the mole bait article. However, it should be appreciated that any readily-digestible combination of elastomers and (if necessary) plasticizers that are attractive and palatable to moles can be used in a mole bait article according to this invention.

For example, sorbitol and glycerin are types of polyhydric alcohols. It should be appreciated that one or more other polyhydric alcohols can be used as the plasticizer in place of one or both of the sorbitol or glycerin. However, many such polyhydric alcohols will not work, and others will work, but not as well as sorbitol or glycerin.

Thus, it should be appreciated that any mole bait article which has an elastomer, and possibly one or more plasticizers to modify the properties of the elastomer, that are able to provide, when combined, a mole bait article that has acceptable values for the elasticity, the distance to break, the elasticity memory and/or the digestibility (especially when a single dose mole bait article is desired), and which is otherwise attractive and palatable to a mole such that the mole consumes the mole bait article, can be used in place of the gelatin, and the sorbitol, and/or glycerin, respectively, in a mole bait article according to this invention.

In developing the mole bait article containing gelatin, sorbitol and glycerin according to the above-outlined exemplary embodiment, the applicants screened a large number of elastomers and plasticizers. This screening included determining an appropriate ratio of components by stretching the resultant mole bait article, where the length of the mole bait article was measured before, during and after stretching. This screening also included stretching the mole bait article until the mole bait article broke, thus allowing the tensile strength of the mole bait article to be determined. This screening included providing the mole bait article having the identified formula to moles and observing whether the moles would consume the resultant mole bait article. Finally, this screening included determining whether the mole bait article, when digested by the moles, is sufficiently digestible that a single mole bait article releases an effective amount of the active ingredient into the moles' systems.

Based on this screening, the inventors have determined that a formula of three parts gelatin to seven parts sorbitol to one part glycerin provides an optimal mole bait article with respect to the combination of the mole bait article's physical properties and digestibility. It should be appreciated that, in this mole bait article, there are other constituents of the mole bait article that can make up from one to fourteen additional parts. These additional constituents of the mole bait article are generally inert with respect to the elasticity, tensile strength, elasticity memory and digestibility, in that they generally have, at most, a slight effect on these properties.

These other constituents include colorants, attractants, and one or more active ingredients that the mole bait article is being used to introduce into the mole's system. It should be appreciated that such active ingredients can include poisons and other materials which are toxic to the mole, nutritive elements, medicines and the like that may be desirable to introduce into the mole's system. For example, if the person using a mole bait article according to this invention wishes to exterminate one or more moles, because the moles are destroying the person's garden, lawn or the like, the active ingredient in the mole bait article can include any effective toxin or poison.

However, it should be appreciated that, based on observations of moles undertaken by the applicants, the applicants have determined that, due to moles' very high metabolic rates, and very low dwell times for food items in the moles' digestive tracts, as discussed above, many conventional mole baits are not able to deliver, into a mole's system, a lethal dose of a typically-used poison or toxin using a single mole bait article. Moreover, for many conventional mole baits, even when moles consume multiple ones of the mole bait article, the moles do not do so sufficiently closely enough in time to create a lethal amount of the poison or toxin in the mole's system.

In contrast, in various exemplary embodiments of the mole bait article according to this invention, the mole bait article is sufficiently digestible that a single mole bait article according to this invention, upon being consumed and digested, is able to release an effective dose of the active ingredient to the mole. For example, the applicants have determined that a mole bait article according to this invention containing bromethalin at a concentration of approximately 0.025% by weight of the mole bait article is effective in killing moles. Bromethalin, which is an ATP inhibitor, stops the conversion of food into energy. This lack of energy affects the mole's central nervous system, causing paralysis and heart and/or lung failure.

Bromethalin is absorbed sufficiently quickly from the mole bait article according to this invention into the mole's system, over the time frame in which the mole bait article according to this invention remains within the mole's digestive system, such that the mole will receive a lethal dose from a single one of the mole bait articles according to this invention. It should be appreciated that, for a mole bait article that is to deliver a lethal dose of one or more active ingredients, the one or more active ingredients can include anticoagulants, including, but not limited to, bromadiolone, brodifacoum, difenacoum, difethialone, diphacinone and/or chlorphacinone, as well as other materials that are toxic or poisonous to moles, including, but not limited to, bromethalin, zinc phosphide and/or strychnine. Other active ingredients can include nutritive elements, such as proteins, fats, carbohydrates, vitamins, trace elements and the like, and/or medicinal elements, such as therapeutic pharmaceuticals, contraceptives, and the like.

As indicated above, besides poisons and other toxins, active ingredients that can be introduced to the mole using the mole bait article according to this invention include nutritive elements, medicines, and the like. For example, it may be necessary to provide medicines and/or nutritive elements to a population of captive moles. For example, it may be that the food provided to the population of captive moles is missing some vitamin, trace compound or element, or other nutritive element that moles need and normally obtain from their environment in the wild. If the food provided to the captive moles is lacking in this nutritive element, the mole bait article according to this invention can be used to provide such nutritive elements to the moles. Similarly, if a captive population of moles, or an individual mole, require some type of medicine be introduced into their systems, it may be most efficacious to provide such medicines to the mole(s) using the mole bait article according to this invention.

As mentioned above with respect to one exemplary embodiment of the mole bait article according to this invention, one particularly useful formula for creating the mole bait article according to this invention comprises using three parts gelatin, seven parts sorbitol, and one part glycerin. It should be appreciated that, in various exemplary embodiments of the mole bait article according to this invention, this formula is obtained by providing a mole bait article having 12% gelatin, 28% sorbitol, and 4% glycerin by weight, with the remaining 56% by weight comprising one or more active ingredients, fillers, attractants, and/or other inert materials, i.e., materials that do not significantly affect the overall elasticity, tensile strength, and/or elasticity memory of the mole bait article. It should be appreciated that the proportion of gelatin in such a mole bait article can range from 5% to 17% by weight, while the proportion of sorbitol can range from 7% to 35% by weight and the proportion of glycerin can range from 1% to 44% by weight.

It should be appreciated that the total percentage of the elastomer and plasticizer components in the mole bait article is generally limited by the need to include sufficient amounts of the other components, such as the active ingredient(s), any attractants, and the like, in the mole bait article. For example, in various exemplary embodiments of the mole bait article 100 shown in FIG. 1, the total percentage of the gelatin, sorbitol and glycerin is at most around 40%-50%.

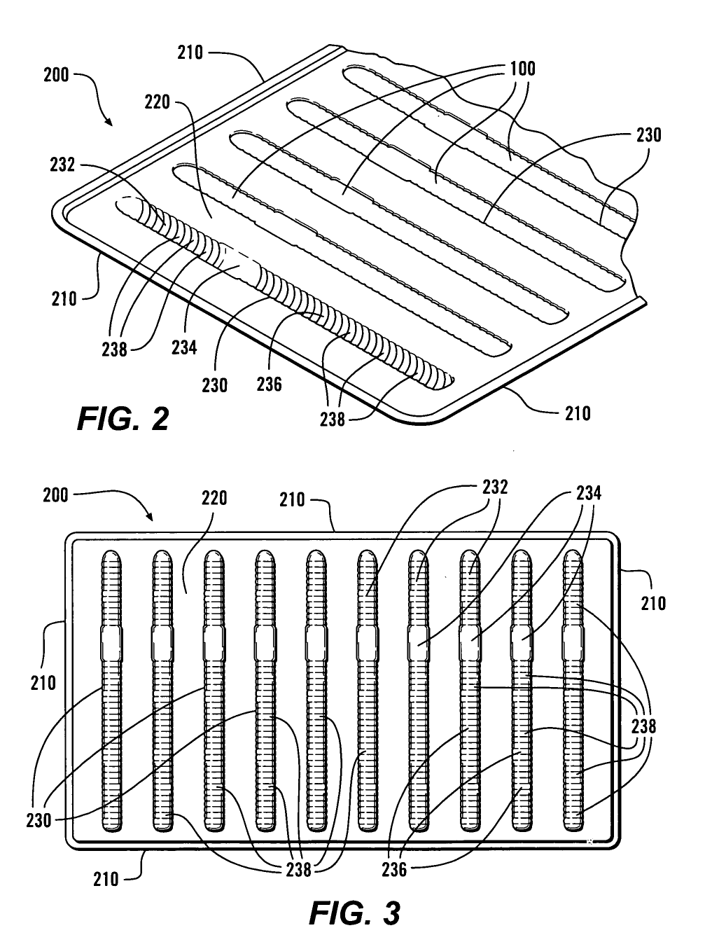

FIG. 2 is a top perspective view of one exemplary embodiment of a tray 200 used to form and ship one exemplary embodiment of a mole bait article according to this invention. As shown in FIG. 2., the tray 200 includes a plurality of depressions 230, where each depression 230 includes specific shape details of a worm-shaped mole bait article to be formed and shipped using the tray 200. In particular, the exemplary embodiment of the tray 200 shown in FIG. 2 has depressions 230 that contain the specific shape details of an earthworm. In particular, each depression 230 includes an anterior portion 232, a clitellum 234, and a posterior portion 236, where each of the anterior portion 232 and the posterior portion 236 include pluralities of segments 238. Thus, the particular exemplary embodiment of the tray 200 shown in FIG. 2 is usable to create the mole bait article 100 shown in FIG. 1.

FIG. 3 is a bottom plan view of the tray 200. In FIG. 3, the anterior portion 232, the clitellum 234, the posterior portion 236, and the segments 238 that make up the anterior and posterior portions 232 and 236 of the depression 230 that is usable to form the worm-shaped mole bait article 100 shown in FIG. 1 can be seen in greater detail.

As shown in FIG. 2, the tray 200 is used to form a mole bait article 100 according to this invention by pouring or otherwise introducing a moldable mole bait material into each of the plurality of depressions 230. It should be appreciated that this moldable mole bait material can be a liquid, a paste, a slurry, a powder, or any other material phase that can be introduced into the depressions 230 and take the shape of the depressions 230 such that, when the material is set or otherwise fixed in form, it retains the specific shape details of the depressions 230 after being removed from the depressions 230. As shown in FIG. 2, the tray 200 includes a plurality of edges 210 that rise above a surface 220 in which the depressions 230 are formed.

In various exemplary embodiments according to this invention, the mole bait article 100 shown in FIG. 1 is formed by introducing a liquid, powder, or paste-like mole bait material into each of the depressions 230 in sequence from one end of the tray 200 to the other end of the tray 200. Subsequently, the liquid, powder or paste-like mole bait material is cured, allowed to set, or otherwise processed to convert the liquid, powder or paste-like mole bait material into a worm-shaped mole bait article that has, and retains, the shape of the depression 230. It should be appreciated that, in the exemplary embodiment shown in FIG. 2, the exemplary tray 200 contains depressions that extend about 150° to about 210° around the circumference of the worm-shaped mole bait article 100. The mole bait article 100 formed using the tray 200 is then shipped in the tray 200 to the end user, who removes the mole bait article 100 from the depression 230.

It should also be appreciated that, in various exemplary embodiments, the mole bait article can be formed using a full 360° mold surface, such as a tray having at least two portions, or a tray containing a depression 230 that extends into the surface 220 of the tray 200 along the axial length of the mole bait article, rather than, as shown in FIG. 2, a depression that extends into the surface 220 along the radial dimension of the mole bait article. Alternately, the tray 200 can include two portions that are mated together to form the 360° mold. In such cases, the mole bait material can be introduced into such depressions 230, for example, by injection molding techniques, pouring, and the like. In such cases, it will generally be necessary to disassemble or otherwise open the two portions of the tray or open the depressions to allow the mole bait article to be removed. It should further be appreciated that any other appropriate molding technique can be used to make the mole bait article according to this invention.

It should be appreciated that the tray 200 can be formed using any appropriate material, such as a metal or foil sheet, a plastic sheet or the like, with the depressions 220 formed using any appropriate method. It should be appreciated that it may be desirable to use a release agent with the tray 200 to more easily facilitate removing the molded mole bait article 100 from the tray 200. If a release agent is used, the release agent can be applied to the surface 220 of the tray 200 or can be incorporated into the material of the tray 200. In various exemplary embodiments, the tray 200 is formed from sheets of a multilayered material that includes layers of high-impact polystyrene (HIPS) and linear, low-density polyethylene (LLPDE) and that incorporates EZ-Peel®, a proprietary release substance. This multilayered material can be obtained from Curwood, Inc. of Oshkosh, Wis. However, it should be appreciated that any conventional release agent may be used that is effective and compatible with the various components of tray 200 and/or the molded mole bait article 100 and that does not adversely effect the mole bait article 100.

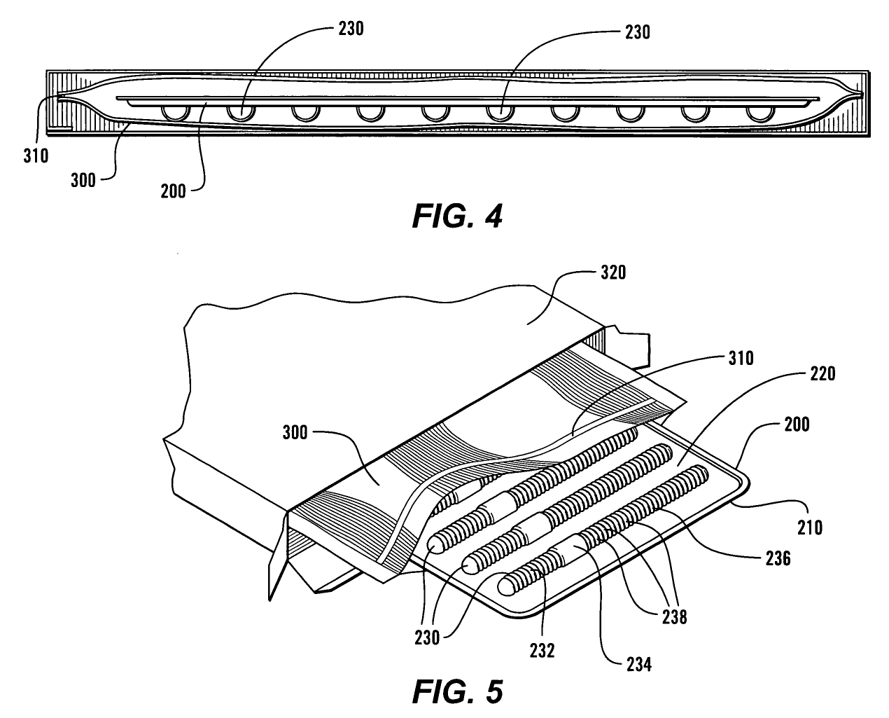

FIG. 4 is a cross-sectional view showing a tray 200, a pouch 300 in which at least one tray 200 can be stored, and a box 320 in which the pouch 300 and the at least one tray 200 can be shipped. FIG. 5 shows a bottom perspective view of the open box 320 containing the pouch 300 in which the at least one tray 200 is stored. As shown in FIG. 4, the at least one tray 200 is placed inside the pouch 300. The pouch 300 includes a resealable seal 310 at a closed end of the pouch 300. In various exemplary embodiments, the pouch 300 is formed using a water-impermeable material, and/or the pouch material is treated to render the pouch water-impermeable. This prevents desiccation of the molded mole bait article 100 due to loss of water through the pouch material.

After the at least one tray 200 is placed in the pouch 300, an open end of the pouch 300 is also sealed and the pouch placed in the box 320. In various exemplary embodiments, as part of sealing the open end of the pouch 300, any air (or, in general, oxygen-containing gas) is evacuated or removed from the pouch 300 and an inert gas is placed into the pouch 300. In various exemplary embodiments, the inert gas is used to prevent oxidation of the mole bait material or any ingredients in the mole bait article 100. Typically, the inert gas is nitrogen. However, any gas that tends to prevent oxidation of the ingredients, and especially of the active ingredient, of the mole bait article can be used as the inert gas.

After purchase, distribution or the like, the end user opens the box 320 and removes the pouch 300 from the box 320. The user then opens the sealed pouch 300 at the end containing the seal 310. The user then opens the resealable seal 310 and withdraws one or more of the at least one tray 200 that is stored in the pouch 300. After removing one or more of the mole bait articles 100 from the corresponding depressions 230 in the removed at least one tray 200, the user returns the at least one tray 200 to the pouch 300 and reseals the pouch 300 using the reusable seal 310.

In the exemplary embodiment shown in FIG. 5, the seal 310 is a zipper-like seal having a male portion that is forced into a female portion. However, it should be appreciated that any resealable or reusable seal 310 can be used with the pouch 300.

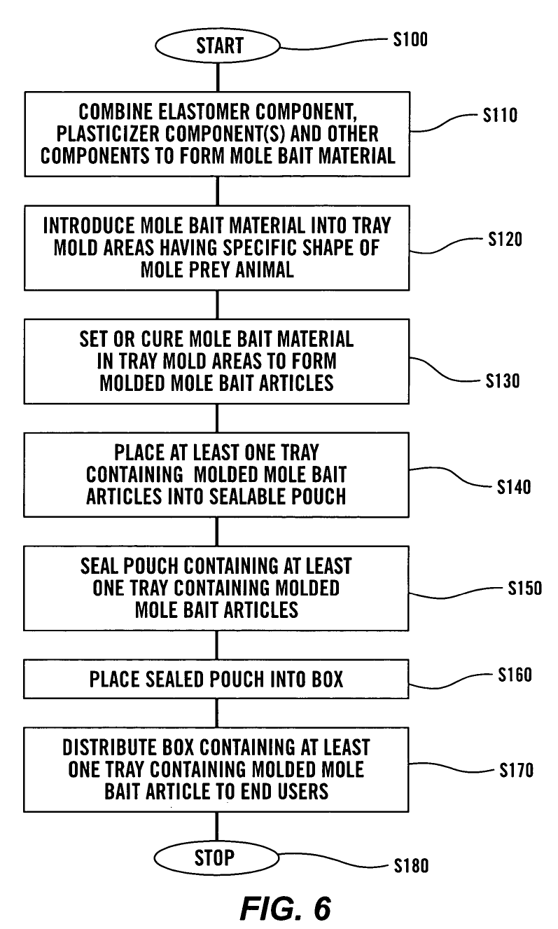

FIG. 6 is a flowchart showing one exemplary embodiment of a method for making and distributing a molded mole bait article having the shape of a prey animal of a mole according to this invention. As shown in FIG. 6, operation of the method begins in step S100, and continues to S110, where the gelatin, as the elastomer, and the sorbitol and the glycerin, as the plasticizers, along with various other materials are combined to form a mole bait material. Then, in step S120, the mole bait material is introduced into mold areas of a tray, where the mold areas have the specific shape of a mole prey animal. Next, in step S130, the mole bait material, is set or cured in the mole bait areas of the tray to form the molded mole bait articles according to this invention. Operation then continues to step S140.

In step S140, one or more of the trays containing the molded mole bait articles are placed into a sealable pouch. Then, in step S150, the pouch containing the one or more trays containing the molded mole bait articles are sealed. Next, in step S160, the sealed pouch is placed into a box containing various graphics, instruction for use, government mandated warnings and the like. Then, in step S170, the box containing the resealable pouch, which in turn contains the one or more trays containing the molded mole bait articles, are distributed to various end users either directly or indirectly using any desirable channel of commerce. Operation then continues to step S180, where operation of the method ends.

It should be appreciated that, in step S170, the manufacturer of the boxed, sealed mole bait articles may transfer them directly to trained mole exterminators. Alternatively, the manufacturer can distribute the boxed, sealed mole bait articles through zero, one or more intermediate distributors and wholesalers to a final retailer or distributor. The retailer can then sell the boxed sealed mole bait articles to the final end user.

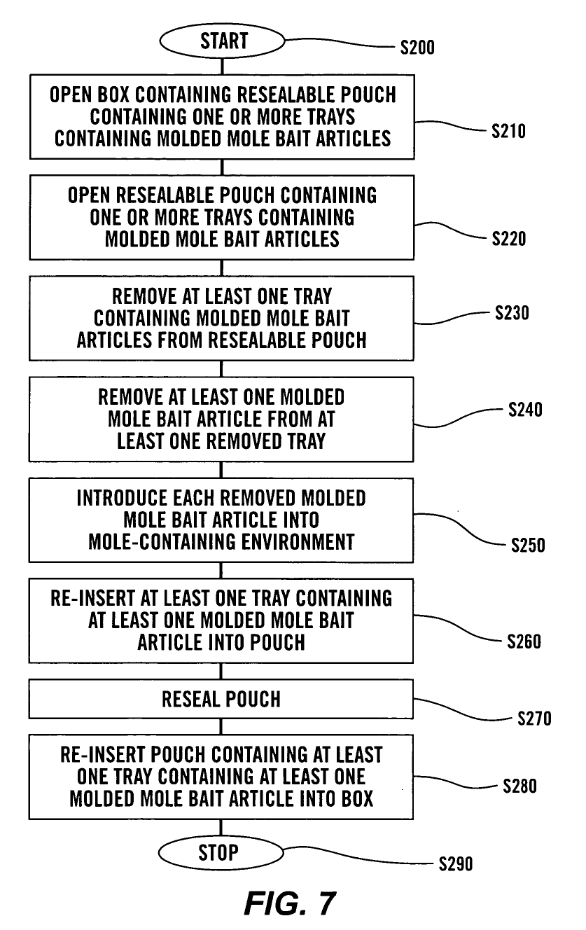

FIG. 7 is a flowchart outlining one exemplary embodiment of a method by which an end user uses a molded mole bait article according to this invention. As shown in FIG. 7, beginning in step S200, operation continues to step S210, where the end user opens the box containing the resealable pouch that in turn contains one or more trays containing molded mole bait articles according to this invention. Then, in step S220, the end user opens the resealable pouch containing one or more trays that in turn contains molded mole bait articles according to this invention. Next, in step S230, the end user removes at least one tray containing at least molded mole bait article from the resealable pouch. Operation then continues to step S240.

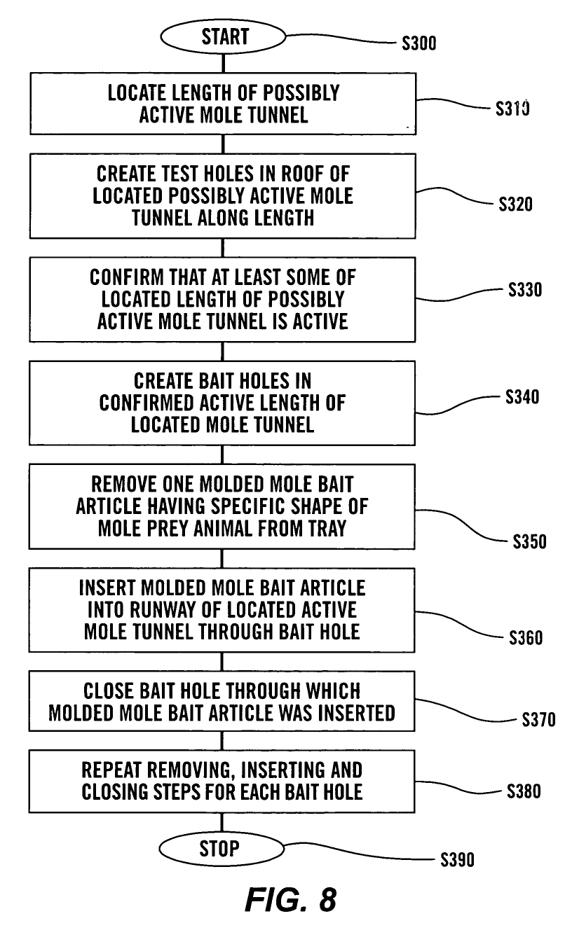

In step S240, the end user removes at least one molded mole bait article from the at least one removed tray. Then, in step S250, the end user introduces each molded mole bait article into the mole-containing environment. This is described in great detail with respect to FIG. 8. Then, in step S260, at least one tray that continues to contain at least one molded mole bait article, if any such trays remain, is reinserted into the resealable pouch. Operation then continues to step S270.

In step S270, the resealable pouch is resealed. Then, in step S280, the resealed pouch is reinserted into the box. Operation then continues to step S290, where operation of the method ends.

FIG. 8 is a flowchart outlining one exemplary embodiment of a method according to this invention for inserting a molded mole bait article according to this invention into an environment that contains one or more moles the user wishes to interact with the mole bait article. As shown in FIG. 8, beginning in step S300, operation continues to step S310, where a length of a structure that could be an active mole tunnel is identified. Then, in step S320, a number of test or assessment holes are created, along the identified length, in the roof of the identified structure that could be an active mole tunnel. It should be appreciated that this is typically done by an extermination professional to establish mole activity. In response to the test or assessment holes being formed in an active mole tunnel or runway, the mole, during active periods, travels along the active mole runway, observes the test or assessment holes, and repairs them. Next, in step S330, the test or assessment holes made in the length of the structure that could be an active mole tunnel or runway are inspected to confirm whether that length of the structure is an active mole tunnel. Operation then continues to step S340.

In step S340, for a structure that is confirmed to be an active mole tunnel, a number of bait holes are made into the roof of the active mole tunnel, It should be appreciated that, in various exemplary embodiments, the diameters of the bait holes should be at least slightly larger than the diameter of the molded bait article. Next, in step S350, a molded mole bait article according to this invention is removed from the tray it was molded in. Then, in step S360, the removed molded mole bait article is inserted through one of the bait holes. Operation then continues to step S370.

It should be appreciated that, in various exemplary embodiments, the molded mole bait article is not merely stuffed down the bait hole and into the active mole tunnel, but rather is carefully inserted through the bait hole into the active mole tunnel such that the entire length of the mole bait article is placed into the active mole tunnel and such that the mole bait article lies on the floor of the active mole tunnel. In various exemplary embodiments, the mole bait article can be pushed through the bait hole using a finger, or a rod or other elongated, sufficiently stiff or rigid, member.

In step S370, the bait hole is closed, so that the mole does not notice that this active mole tunnel has been tampered with. It should be appreciated that this can be accomplished by pinching dirt over the bait hole, by placing a small object, such as an appropriately-sized rock or other small object, over the bait hole. However, it should be appreciated that any effective technique can be used to close off the bait hole. Then, in step S380, the removing, inserting and closing steps should be repeated for each bait hole that was created in step S340. Operation then continues to step S390, where operation of the method ends. It should be appreciated that, in various exemplary embodiments, steps S310-S380 can be repeated for a number of lengths of suspected active mole tunnels.

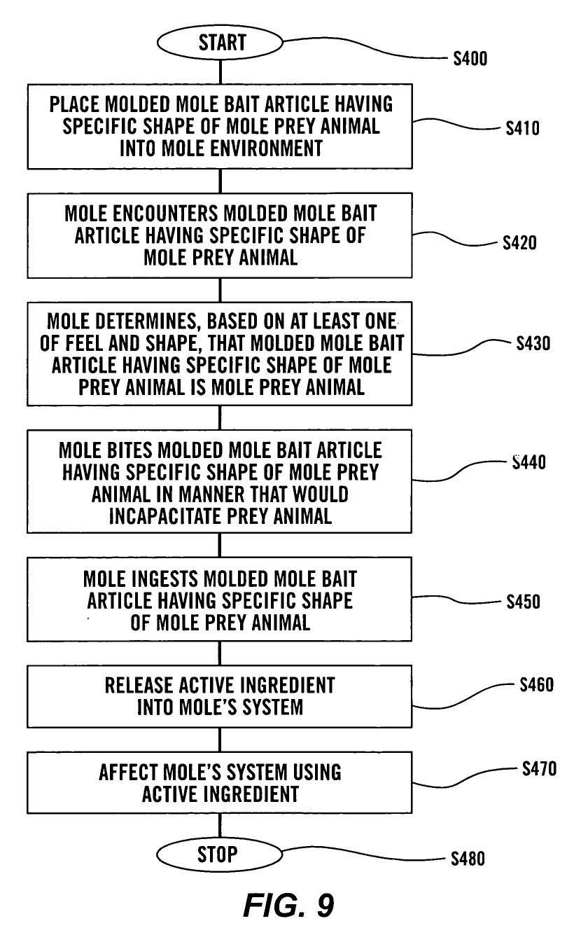

FIG. 9 is a flowchart outlining one exemplary embodiment of a method by which a mole interacts with a prey-animal shaped mole bait article according to this invention. As shown in FIG. 9, beginning in step S400, operated continues to step S410, where the prey-animal molded mole bait article having a specific shape of a mole prey animal is placed into the mole's environment. Then, in step S420, the mole encounters the molded mole bait article having a specific shape of the mole prey animal. Next, in step S430, the mole determines, based on at least one of a feel and a shape of the molded mole bait article, that the molded mole bait article having the specific shape of the mole prey animal is in fact, as far as the mole understands, a prey animal. Operation then continues to step S440.

In step S440, the mole bites the molded mole bait article having the specific shape of the mole prey animal in a manner that is intended to incapacitate the mole prey animal that the mole believes it has encountered. Next, in step S450, the mole ingests the molded mole bait article having the specific shape of the mold prey animal. Then, in step S460, one or more active ingredients are released from the ingested mole bait article into the mole's system. Operation then continues to step S470.

In step S470, the active ingredient, having been released from the molded mole bait article, begins to affect or interact with the mole's body. Operation then continues to step S480, or operation of the method ends.

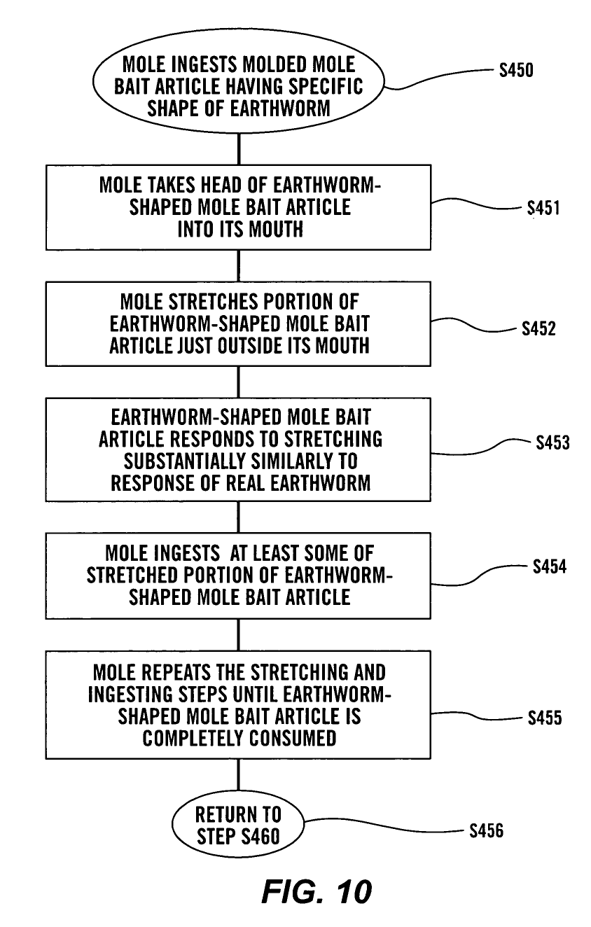

FIG. 10 is a flowchart outlining in greater detail one exemplary embodiment of a method by which the mole ingests or introduces the molded mole bait article having the specific shape into its system. In particular, with respect to FIG. 10, the particular prey animal whose shape is mimicked by the molded mole bait article is an earthworm. Thus, beginning in step S450, operation continues to step S451, where the mole takes the “head” of the earthworm-shaped mole bait article into its mouth. Then, in step S452, the mole stretches at least a portion of the earthworm-shaped mole bait article that lies just outside its mouth. Next, in step S453, the earthworm-shaped mole bait article responds to the stretching substantially similarly as the response of a real earthworm. Operation then continues to step S454.

In step S454, the mole releases the stretched portion of the earthworm-shaped mole bait article that was stretched, for example, to force any undesirable materials from the digestive system of the worm. Next, in step S455, the mole repeats the stretching and ingesting steps until the earthworm-shaped mole bait article is completely consumed. Then, in step S456, operation returns to step S460.

While this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the invention is intended to embrace all known or later-developed alternatives, modifications variations, improvements, and/or substantial equivalents.

1. A mole bait article containing a dose of an active ingredient which is to be introduced into a mole, wherein the mole bait article imitates at least one of a feel and shape of a prey animal of a mole.

2. The mole bait article of claim 1, wherein the prey animal is a worm and the mole bait article imitates at least one of the shape and the feel of the worm.

3. The mole bait article of claim 2, wherein, in imitating the feel of the worm, the mole bait article imitates at least one of an elasticity and recovery of the worm.

4. The mole bait article of claim 3, wherein, in imitating an elasticity of the worm, at least a portion of the mole bait article can be stretched to between about 150% to about 200% of an original, pre-stretch length of that portion of the mole bait article before breaking.

5. The mole bait article of claim 4, wherein at least the portion of the mole bait article can be stretched to between about 155% to about 175% of the original, pre-stretch length of that portion of the mole bait article before breaking.

6. The mole bait article of claim 5, wherein at least the portion of the mole bait article can be stretched to between about 157% to about 160% of the original, pre-stretch length of that portion of the mole bait article before breaking.

7. The mole bait article of claim 6, wherein at least the portion of the mole bait article can be stretched to about 158% of the original, pre-stretch length of that portion of the mole bait article before breaking.

8. The mole bait article of claim 3, wherein, in imitating an recovery of the worm, the mole bait article has at least an elasticity memory such that at least a portion of the mole bait article that has been stretched returns to a post-stretch length of between about 100% to about 108% of the original, pre-stretch length of that portion of the mole bait article.

9. The mole bait article of claim 8, wherein at least the portion of the mole bait article that has been stretched returns to a post-stretch length of between about 102% to about 107% of the original, pre-stretch length of that portion of the mole bait article.

10. The mole bait article of claim 8, wherein at least the portion of the mole bait article that has been stretched returns to a post-stretch length of between about 104% to about 106% of the original, pre-stretch length of that portion of the mole bait article.

11. The mole bait article of claim 8, wherein at least the portion of the mole bait article that has been stretched returns to a post-stretch length of about 105% of the original, pre-stretch length of that portion of the mole bait article.

12. The mole bait article of claim 2, wherein, in imitating the feel of the worm, the mole bait article imitates at least one of a degree of stretch and a degree of recovery from stretch of the worm.

13. The mole bait article of claim 12, wherein, in imitating a degree of stretch of the worm, at least a portion of the mole bait article can be stretched to between about 150% to about 200% of an original, pre-stretch length of that portion of the mole bait article before breaking.

14. The mole bait article of claim 13, wherein at least the portion of the mole bait article can be stretched to between about 155% to about 175% of the original, pre-stretch length of that portion of the mole bait article before breaking.

15. The mole bait article of claim 14, wherein at least the portion of the mole bait article can be stretched to between about 157% to about 160% of the original, pre-stretch length of that portion of the mole bait article before breaking.

16. The mole bait article of claim 15, wherein at least the portion of the mole bait article can be stretched to about 158% of the original, pre-stretch length of that portion of the mole bait article before breaking.

17. The mole bait article of claim 3, wherein, in imitating a degree of recovery of the worm, at least a portion of the mole bait article that has been stretched returns to a post-stretch length of between about 100% to about 108% of the original, pre-stretch length of that portion of the mole bait article.

18. The mole bait article of claim 17, wherein at least the portion of the mole bait article that has been stretched returns to a post-stretch length of between about 102% to about 107% of the original, pre-stretch length of that portion of the mole bait article.

19. The mole bait article of claim 17, wherein at least the portion of the mole bait article that has been stretched returns to a post-stretch length of between about 104% to about 106% of the original, pre-stretch length of that portion of the mole bait article.

20. The mole bait article of claim 17, wherein at least the portion of the mole bait article that has been stretched returns to a post-stretch length of about 105% of the original, pre-stretch length of that portion of the mole bait article.

21. The mole bait article of claim 2, wherein, in imitating the shape of the worm, the mole bait article imitates an anterior portion of the worm, a clitellum of the worm and a posterior portion of the worm.

22. The mole bait article of claim 21, wherein, in imitating the anterior portion of the worm, the mole bait article imitates a head portion of the worm and a plurality of segments of the worm.

23. The mole bait article of claim 21, wherein, in imitating the posterior portion of the worm, the mole bait article imitates a tail portion of the worm and a plurality of segments of the worm.

24. The mole bait article of claim 2, wherein, in imitating the shape of the worm, a surface of the mole bait article that imitates the shape of the worm extends between about 150 degrees and about 210 degrees around the circumference of the worm.

25. The mole bait article of claim 24, wherein, in imitating the shape of the worm, the surface of the mole bait article that imitates the shape of the worm extends about 180 degrees around the circumference of the worm.

26. The mole bait article of claim 1, wherein:
the prey animal is a worm and the mole bait article comprises:
at least one digestible elastomer,
at least one digestible plasticizer, and
at least one active ingredient; and
proportions of the at least one digestible elastomer and the at least one digestible plasticizer in the mole bait article provide the mole bait article with a feel that imitates the feel of the worm.

27. The mole bait article of claim 26, wherein:
the at least one digestible elastomer comprises gelatin; and
the at least one digestible plasticizer comprises sorbitol and glycerin.

28. The mole bait article of claim 27, wherein the proportions of the gelatin to the sorbitol and glycerin in the mole bait article comprise three parts gelatin to seven parts sorbitol to one part glycerin.

29. The mole bait article of claim 27, wherein the gelatin, the sorbitol and the glycerin together are about 40% to about 50% by weight of the mole bait article.

30. The mole bait article of claim 29, wherein the remaining about 50% to about 60% by weight of the mole bait article comprises the at least one active ingredient and zero, one or more of:
at least one filler;
at least one attractant; and
at least one other inert material.

31. The mole bait article of claim 27, wherein the mole bait article comprises about 5% to about 17% gelatin by weight.

32. The mole bait article of claim 27, wherein the mole bait article comprises about 7% to about 35% sorbitol by weight

33. The mole bait article of claim 27, wherein the mole bait article comprises about 1% to about 44% glycerin by weight

34. The mole bait article of claim 27, wherein the proportions of the gelatin to the sorbitol and glycerin in the mole bait article comprise about 12% gelatin, about 28% sorbitol, and about 4% glycerin by weight.

35. The mole bait article of claim 27, wherein the at least one active ingredient comprises at least one of:
at least one poison or toxin;
at least one nutritive substance; and
at least one medicinal substance.

36. The mole bait article of claim 35, wherein the at least one poison or toxin comprises at least one of bromadiolone, brodifacoum, difenacoum, difethialone, diphacinone, chlorphacinone, bromethalin, zinc phosphide and/or strychnine.

37. The mole bait article of claim 1, wherein the mole bait article includes, along a length:
at least one first region having a first dimension across the length; and
at least one second region having a second dimension across the length that is less than the first dimension.

38. The mole bait article of claim 37, wherein the mole bait article further includes, along its length, at least one third region having a third dimension across the length that is greater than the first dimension.

39. The mole bait article of claim 37, wherein the mole bait article further includes at least one third region that tapers.

40. A packaged mole bait, comprising at least one tray containing at least one mole bait article, each tray comprising:
a first surface, and
at least one depression formed in the first surface and having a shape usable to create a desired shape of the mole bait article;
wherein the at least one mole bait article having the desired shape is formed by introducing a quantity of a moldable mole bait material into each of the at least one depression.

41. The packaged mole bait of claim 40, further comprising a resealable pouch containing the at least one tray.

42. The packaged mole bait of claim 41, further comprising a secondary package containing the resealable pouch, the secondary package containing thereon at least one image, a list of ingredients of the mole bait article and a product name of the mole bait article.

43. The packaged mole bait of claim 40, wherein the pouch further contains an inert gas.

44. The packaged mole bait of claim 40, wherein the pouch comprises a water-impermeable material.

45. The packaged mole bait of claim 40, wherein each at least one depression has a first dimension corresponding to a length of the mole bait article and a second dimension corresponding to at least a portion of a circumference of the mole bait article, the first dimension extending along the first surface and the second dimension extending into the first surface.

46. The packaged mole bait of claim 40, wherein each at least one depression has a first dimension corresponding to a length of the mole bait article and a second dimension corresponding to at least a portion of a circumference of the mole bait article, the first dimension extending into the first surface and the second dimension extending along the first surface.

47. The packaged mole bait of claim 46, wherein the tray comprises a first portion and a second portion, the first and second portions combined to form the at least one depression.

48. The packaged mole bait of claim 40, wherein each tray comprises a moldable plastic material that includes a release agent.

49. The packaged mole bait of claim 40, wherein the tray further comprises a release agent applied to the first surface.

50. A method for making a mole bait article, comprising:
combining together a plurality of ingredients to form a mole bait material;
placing the mole bait material into at least one tray, each tray containing at least one mold depression usable to shape a quantity of the mole bait material;
allowing the mole bait material placed into at least one mold depression to set; and
packaging the at least one tray containing the molded mole bait material into a resealable pouch.

51. The method of claim 50, further comprising obtaining a plurality of the trays.

52. The method of claim 50, wherein obtaining the plurality of the trays comprises:
obtaining a plurality of deformable sheets; and
forming a negative shape relative to a shape desired for the mole bait article.

53. The method of claim 50, further comprising placing the resealable pouch into a secondary package.

54. The method of claim 50, wherein packaging the at least one tray containing the molded mole bait material into the resealable pouch comprises:
placing the at least one tray into the pouch through an open end of the pouch;
removing an oxygen-containing gas from the pouch
adding an inert gas into the pouch; and
sealing the open end of the pouch.

55. A method for using a mole bait article, comprising:
opening a resealable pouch containing at least one tray containing at least one mole bait article, each mole bait article having at least one of a shape and a feel that imitates a mole prey animal;
removing at least one of the at least one tray from the pouch;
removing at least one mole bait article from at least one of the at least one tray; and
placing the mole bait article into an environment where a mole is likely to encounter the mole bait.

56. The method of claim 55, wherein the mole bait article is a worm and placing the mole bait article comprises placing the worm into a hole in the earth occupied by the mole.

57. The method of claim 55, wherein the mole bait article is a worm and placing the mole bait article comprises:
locating a possibly-active mole tunnel;
creating a plurality of test holes in the located possibly-active mole tunnel along a length of the possibly-active mole tunnel;
examining, after a period of time has elapsed, the located possibly-active mole tunnel to determine if the possibly-active mole tunnel is active;
if the possibly-active mole tunnel is active, creating a plurality of bait holes along an active portion of the located mole tunnel;
introducing, for each bait hole, at least one mole bait article into the located mole tunnel through that bait hole, such that the entire mole bait article is within the mole tunnel and is placed along a floor of the mole tunnel; and
closing the plurality of bait holes.

58. A method for introducing an effective amount of desired active ingredient into a mole, comprising:
placing a mole bait article, imitating at least one of a feel and a shape of a prey animal of the mole and containing an effective amount of the active ingredient, into an environment where the mole bait article is likely to be encountered by the mole;
the mole encountering the mole bait article, and determining, based on at least one of a shape and a feel of the mole bait article, that the mole bait article is the prey animal;
the mole biting the mole bait article in a manner that would incapacitate the prey animal;
the mole taking a head portion of the mole bait article into its mouth and stretching a body portion of the mole bait article, where the mole bait article reacts to the stretching in a way which is substantially similar to a reaction of the incapacitated prey anima to similar stretching by the mole;
the mole ingesting at least a portion of the mole bait article;
the mole repeating the stretching and ingesting of the mole bait article until the mole bait article is at least partially ingested; and
releasing the active ingredient from the ingested mole bait article into the mole in an amount sufficient to have a desired effect on the mole.

59. A method for introducing an effective amount of desired active ingredient into a mole, comprising:
placing a mole bait article that imitates at least one of a feel and a shape of a prey animal of the mole and that contains an effective amount of the active ingredient, into an environment where the mole bait article is likely to be encountered by the mole, wherein:
the mole bait article has at least one of a shape and a feel of a prey animal to a mole,
the mole bait articles is able to induce the mole to bite the mole bait article in a manner that would incapacitate the prey animal,
the mole bait articles is able to induce the mole to take a head portion of the mole bait article into the mole's mouth and to stretch a body portion of the mole bait article, the mole bait article reacting to the stretching in a way which is substantially similar to a reaction of the incapacitated prey animal to similar stretching by the mole,
the mole bait articles is able to induce the mole to ingest at least a portion of the mole bait article, and
the mole bait articles is able to induce the mole to repeat the stretching and ingesting of the mole bait article until the mole has at least partially ingested the mole bait article; and
releasing the active ingredient from the ingested mole bait article into the mole in an amount sufficient to have a desired effect on the mole.
